(19) United States
(12) Patent Application Publication
(10) Pub. No.: US 2025/0224711 A1
(43) Pub. Date: Jul. 10, 2025

(54) Control System for a Technical Installation with Reduced-Size Views of Installation Images

(71) Applicant: Siemens Aktiengesellschaft, Muenchen (DE)

(72) Inventor: Benjamin Lutz, Pfinztal (DE)

(21) Appl. No.: 18/698,229

(22) PCT Filed: Oct. 3, 2022
(86) PCT No.: PCT/EP2022/077431

§ 371 Date: Apr. 3, 2024

(30) Foreign Application Priority Data
Oct. 5, 2021 (EP) 21201042

(51) Int. Cl. G05B 19/418

(52) U.S. Cl. CPC G05B 19/418; G05B 2219/31472

(57) ABSTRACT

A control system for a technical installation, in particular a processing or production installation, wherein the control system includes an operator station server and an operator station client, where the operator station server generates visualization information and transfers the visualization information to the operator station client for visualization so as to enable the technical installation to be operated and monitored by an operator, where the visualization information includes a first and second installation images of the technical installation, in which digitally represented components of the technical installation and associated measurement data are or can be visually depicted for operation and monitoring of the technical installation, where the control system is configured to visually depict the second installation image to the operator via the operator station client during visual depiction of the first installation image to the operator via the operator station client and as a result of an event occurring.

### CROSS-REFERENCE TO RELATED APPLICATIONS

This is a U.S. national stage of application No. PCT/EP2022/077431 filed 3 Oct. 2022. Priority is claimed on European Application No. 21201042.5 filed 5 Oct. 2021, the content of which is incorporated herein by reference in its entirety.

### BACKGROUND OF THE INVENTION

### 1. Field of the Invention

The invention relates to a method and control system for a technical installation, in particular a process installation or production installation, which has at least one operator station server and at least one operator station client, where the operator station server is configured to generate visualization information and transmit it to the operator station client for visualization in order to enable an operator to control and monitor the technical installation, and where the visualization information comprises at least one first and second image of the technical installation, in which digital representations of components of the technical installation and associated data for operator control and monitoring of the technical installation are or can be visually displayed.

### 2. Description of the Related Art

Technical (industrial) installations are operator-controlled and monitored via installation images in which the technical process is schematically represented by image elements, which are in turn made dynamic by process values and alarms. An alarm management system guides operators of the technical installation to the installation images in which the image elements of the alarm-generating process objects are visualized.

For more detailed monitoring and operator control, operators can open “detailed views” in installation images, such as trend curves, faceplates of process objects, and/or message sequence displays. If alarms from other installation images are now reported during detailed operator control or monitoring in an open installation image, then the operator must decide whether to interrupt the operator control and monitoring activity that they have started to deal with the reported alarms or whether to finish their operator control and monitoring first.

If the operator interrupts their present operator control and monitoring activity (if this is even possible), then the installation image changes mean that it will cost the operator time and effort to return to the state of the installation image prior to the interruption. This is particularly disadvantageous in the case of an incoming alarm of low criticality, for example, which would not even have necessitated interrupting the activity that they had begun. The above-described guidance by the alarm management system can therefore also be disadvantageous if operators have to interrupt their activities due to newly announced alarms because the installation image changes to the installation image announcing the alarm, even if the handling of the alarm that has occurred could have been postponed.

Conventional control systems that present an operator with installation images with a plurality of objects via a plurality of operator station servers are disclosed, for example, in EP 3 637 205 A1 and EP 3 736 647 A1.

### SUMMARY OF THE INVENTION

It is an object of the invention to provide a control system for a technical installation that provides improved operator control and monitoring of the technical installation.

This and other objects and advantages are achieved in accordance with the invention by a control system for a technical installation, in particular a process or production installation and by a method for operating a control system for a technical installation, in particular a process or production installation.

The control system in accordance with the invention is configured such that, if an event occurs during the visual presentation of the first installation image to the operator by the operator station client, then the second installation image is visually presented to the operator via the operator station client, where the display size of the second installation image is smaller than the display size of the first installation image.

In the present context, a control system is to be understood as meaning a computer-aided technical system incorporating functionalities for displaying, operating and controlling a technical installation, such as a manufacturing or production installation. In addition to the operator station server and the operator station client, the control system can comprise other components, such as process or production-related components, which are used to control actuators or sensors.

The technical installation can be an installation from the process industry such as a chemical, pharmaceutical or petrochemical installation or an installation from the food and beverage industry. Also included is any installations from the production industry, facilities in which, for example, cars or goods of all kinds are produced. Technical installations that are suitable for implementing the method in accordance with the invention can also come from the field of energy generation. Wind turbines, solar farms or electric power generating installations are also covered by the term technical installation.

In the present case, an “operator station server” is to be understood as meaning a server that centrally acquires data of an operator control and monitoring system and usually alarm and measured value archives of the control system for the technical installation and makes them available to users. The operator station server generally establishes a communication connection to automation systems (such as an automation device) of the technical installation and forwards data from the technical installation to at least the operator station client, which can be used for operator control and monitoring of the operation of the individual functional elements of the technical installation.

The operator station server can itself have client functions in order to access the data (archives, messages, tags, variables) of other operator station servers. This means that images of operation of the technical installation on the operator station server can be combined with variables from other operator station servers (server-server communication). The operator station server can be, but is not limited to, a SIMATIC PCS 7 Industrial Workstation Server from the company SIEMENS.

An operator is to be understood as meaning a human operator of the technical installation. The operator interacts with the technical installation or its control system via specific user interfaces and controls specific technical functions of the system. For this purpose, the operator can use the operator control and monitoring system of the control system comprising the operator station servers and the operator station clients.

In the case of a process installation, the data of the installation can be process data such as pressure values, temperature values or fill level values, but also messages, for example. The data can represent raw data from sensors. However, it can also be processed by a measuring transducer, a peripheral device, an automation device or another device designed for this purpose.

The operator can use the (first) installation image and the (second) installation image (and possibly other installation images), which are visually presented to them on the operator station client, for the operator control and monitoring of the technical installation. In the installation images, for example, an industrial process can be visualized schematically and made dynamic using block symbols (digital representations) of the individual process objects with which the industrial process is automated. It may be possible for the operator to control the industrial process using “faceplates”, for example, which can be opened, for example, via the dynamic block symbols.

In response to an event occurring, the control system in accordance with the invention is advantageously configured to display a second installation image to the operator. Essentially, the display size of the first installation image differs from the display size of the second installation image. The term “display size” means, for example, the number of pixels that are used to display the installation images on a screen. Due to the different display sizes, the operator can directly obtain an overview of the second installation image (which may be relevant for various reasons) without the first installation image no longer being displayed.

If the operator is controlling and monitoring in the open first installation image, in the case of the control system in accordance with the invention, then they are no longer forced to switch (completely) to the second installation image (and thus close the first installation image) in order to be able to assess whether the event that has occurred requires immediate action or whether action can be delayed until the operator has completed their operator control and monitoring in the first installation image. The control system in accordance with the invention can provide the operator with an overview of the second installation image without them having to stop operator control and monitoring of the first installation image.

The display size of the second installation image is preferably smaller than the display size of the first installation image. The second installation image can be superimposed on the first installation image in the form of a thumbnail view. With particular preference, this can be in the form of an (additional) image window in which the second installation image can be or is displayed. The operator can move this image window in order to relocate it to a suitable position on a display of the operator station client.

The event can be an instruction issued by the operator. This instruction can, for example, take the form of a mouse click, a touch on a touch-sensitive screen or a voice instruction. The initiative is taken by the operator, who in turn themself instructs the control system to display the second installation image in the manner described above when an event occurs, such as the arrival of an alarm message.

The event is preferably the selection of the second installation image (more precisely: a symbol or icon that is referenced to the second installation image) from a list display of the (at least) two installation images. The second installation image in the list display can be provided with a message that has come up in the technical installation, in particular an alarm message. During operator control and monitoring, the operator can see from the list display that an alarm message has arisen in the second installation image, select this second installation image in the list display and have the second installation image displayed. An alarm message is a message that usually requires an immediate response from the operator of the technical installation. A message is understood to be a report of the occurrence of an event that represents a transition from one discrete state within the technical installation to another discrete state.

An event can also be a message arising in the technical installation, in particular an alarm message. In principle, no initiative on the part of the operator is required here. When the alarm message occurs, the control system can automatically display the second installation image in the manner above-described manner, as a “pop-up” image window. However, it is also possible for the control system to first ask the operator whether they would like the second installation image to be displayed. This intermediate step is particularly advantageous if the operator does not (yet) want the second installation image to be displayed automatically at the current time.

The operator can preferably specify the properties that the message must possess in order to trigger the visual display of the second installation image by the operator station client. For example, the operator can specify that only messages that have a particular criticality or a particular origin are taken into account, or that are only addressed to the operator themself.

In a preferred embodiment of the invention, the visual display of the second installation image comprises an overview of alarm messages that are assigned to components of the technical installation that are included in the second installation image. This provides the operator with direct information as to which alarm messages are linked to the second installation image. For example, he can obtain an overview of how many critical or non-critical alarm messages are assigned to components that are displayed in the second installation image.

The objects and advantages in accordance with the invention are also achieved by a method for operating a control system for a technical installation, in particular a process or production installation, which has at least one operator station server and at least one operator station client, where the operator station server is configured to generate visualization information and transmit it to the operator station client for visualization, in order to enable operator control and monitoring of the technical installation, and where the visualization information comprises at least one first and second installation image of the technical installation, in which digital representations of components of the technical installation and associated data for operator control and monitoring of the technical installation are or can be visually displayed.

In a preferred embodiment of the invention, the visualization information additionally comprises at least one third installation image of the technical installation, where, as the result of an event or a plurality of events occurring during the visual presentation of the first installation image to the operator by the operator station client, the control system is configured to visually present the second installation image and the third installation image to the operator via the operator station client, where the display size of the first installation image and the second installation image and of the first installation image and the third installation image are formed differently from one another, and where the display size of the second installation image and the third installation image is preferably smaller than the display size of the first installation image. This is also possible for any number of further installation images.

The method comprises the following steps:
a) visually presenting the first installation image to the operator by the operator station client;
b) visually presenting the second installation image to the operator by the operator station client in response to an event occurring, where the display size of the first installation image and the second installation image are differently from one another, where the display size of the second installation image is preferably smaller than the display size of the first installation image.

The second installation image is preferably displayed in an image window that is established to be movable by the operator on an image display visually displayed by the operator station client.

The visual display of the second installation image preferably includes an overview of alarm messages that are assigned to components of the technical installation that are contained in the second installation image.

The above-described objects and advantages achieved by the use of a control system for operating a technical installation, in particular a production or process installation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described features, characteristics and advantages of the present invention and the manner in which they are achieved will become clearer and more readily comprehensible in conjunction with the following description of an exemplary embodiment which will be explained in more detail with reference to the accompanying drawings, in which:

FIG. 1 shows a first installation image with a superimposed second installation image in accordance with the invention;

FIG. 2 shows an enlarged view of the second installation image from FIG. 1;

FIG. 3 shows the first installation image from FIG. 2 with the superimposed second installation image and a superimposed third installation image;

FIG. 4 shows a schematic diagram of a control system in accordance with the invention; and

FIG. 5 is a flowchart the method in accordance with the invention.

### DETAILED DESCRIPTION OF THE EXEMPLARY EMBODIMENTS

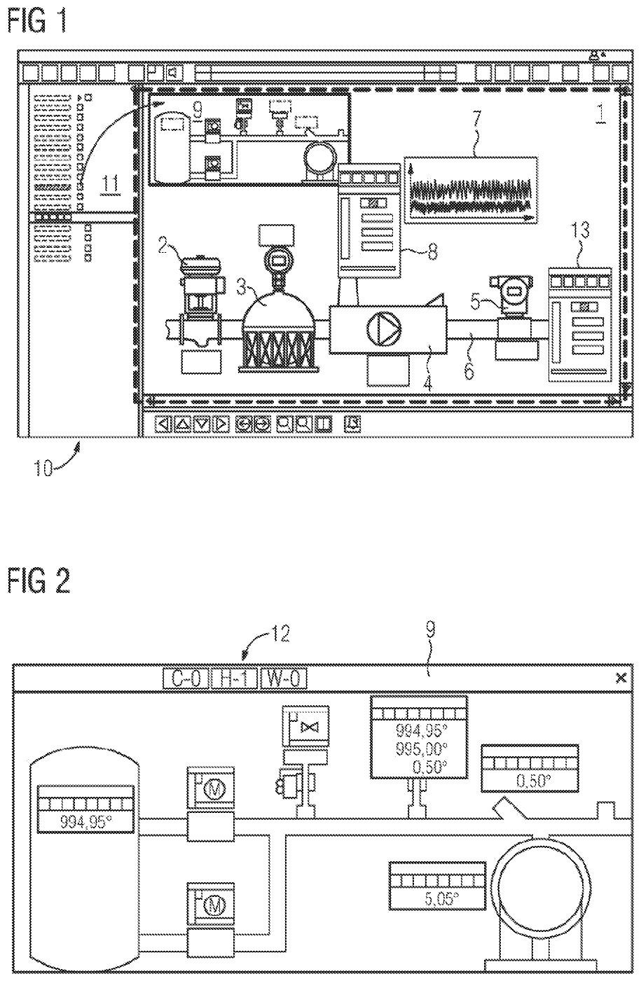

FIG. 1 shows a first installation image 1 of a technical installation formed as an industrial process installation. The first installation image 1 comprises various image objects 2, 3, 4, 5, each visualizing a process component of the installation or rather displaying a digital representation of these process objects. Pipework 6 interconnecting the individual process components can be seen.

The first installation image 1 additionally includes a diagram 7 with measured values of the installation as well as various interfaces 8, 9 for operator control and monitoring of the individual process objects. The first installation image 1 is overlaid in the upper left area by a second installation image 9 which is displayed in a movable image window. Both installation images 1, 9 are shown in a display environment 10 of an operator station client of a control system of the installation. The first installation image 1 is indicated in FIG. 1 by a dashed line, the second installation image 9 by cross symbols.

On the left-hand side of FIG. 1, the display environment 10 shows a list display 11 of the installation images 1, 9. When an alarm message occurs in the installation, the alarm message is displayed in the list display 11. The operator can then select the relevant (second) installation image 9 in the list display 11, thereby causing the second installation image 9 to be visually displayed by the operator station client as shown in FIG. 1. The display size of the second installation image 9 is clearly smaller than the display size of the first installation image 1.

In FIG. 2, the second installation image 9 is shown enlarged. It basically has comparable elements to the first installation image 1, for which reason these will not be discussed in more detail here. In an upper area 12, an overview of alarm messages assigned to components of the installation that are included in the second installation image 9 is displayed. In this exemplary embodiment, one of the components is assigned an alarm message which has the property “critical” (indicated by the designation “H-1” in FIG. 2).

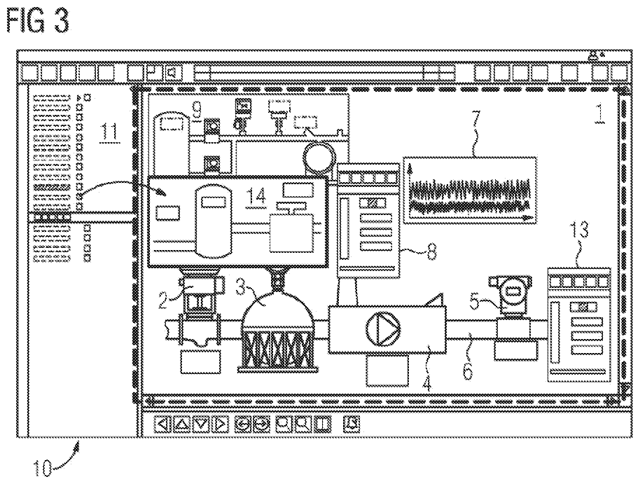

FIG. 3 shows the first installation image 1 together with the superimposed second installation image 9 (cf. FIG. 1). In contrast to the embodiment illustrated in FIG. 1, a third installation image 14 in the form of an image window is superimposed on the first installation image 1. This image window can also be designed to be movable by the operator.

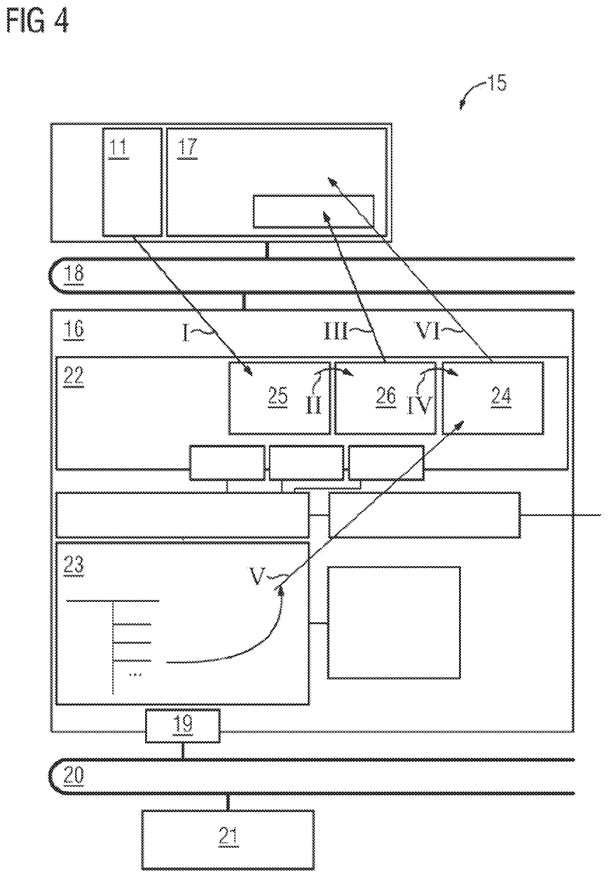

FIG. 4 shows part of an inventive control system 15 of a technical installation formed as a process installation. The control system 15 comprises an operator station server 16 and an operator station client 17.

The operator station server 16 and the operator station client 17 are interconnected via a terminal bus 18 and optionally to other components of the control system 15 (not shown), such as an engineering station server.

A user or operator can access the operator station server 16 for operator control and monitoring purposes via the operator station client 17 via the terminal bus 18. The terminal bus 18 can be formed as and Industrial Ethernet, for example, but is not limited to this option.

The operator station server 16 has a device interface 19 that is connected to an installation bus 20. Via this device interface 19, the operator station server 16 can communicate with an automation device 21 as well as with optionally available further components of the installation such as peripheral devices (not shown). The installation bus 20 can be formed as an Industrial Ethernet, for example, but is not limited to this option. The automation device 21 can be connected to any number of subsystems (not shown).

A visualization service 22 and a process image 23 (among other things) are implemented on the operator station server 16. The operator station client 17 is configured to display installation images for operator control and monitoring of the process installation. The automation device 21 is configured to control and monitor the automation of the process installation. For this purpose, a control program that has been loaded onto the automation device 21 as part of project planning for the automation of the process installation is implemented on the automation device 21. The automation device 21 receives process data (for example, measured values) from the process installation and transmits it to the process image 23 of the operator station server 16.

A specialized display service 24 of the visualization service 22 of the operator station server 16 generates the first installation image 1 (cf. FIGS. 1 and 3) that is transmitted to the operator station client 17 for visualization. As described with reference to FIG. 1, the operator can trigger the visual display of the second installation image 9 on their own initiative (or alternatively the control system 15 can do so automatically). For this purpose, the operator can select the second installation image in the list display 11 of the installation images 1, 9 (step I). A receive service 25 of the operator station server 16 receives the operator's instruction and forwards it to an object service 26 (step II). This object service 26 transmits the visualization information relating to the second installation image 9 to the operator station client 17 so that it can superimpose the second installation image 9 on the first installation image 1 (step III).

In addition, the object service 26 transmits the instruction to the display service 24 to generate an alarm-itemizing overview of alarm messages, which provides the operator with an immediate overview of the alarm messages that are assigned to the second installation image 9 (step IV). To generate this overview, the display service 24 accesses the process image 23 in which information is stored as to which process object has which alarm message (having which property) (step V). Because the display service 24 knows which process objects are assigned to the second installation image 9, the display service 24 can also assign the alarm messages to the second installation image 9 and generate the alarm-itemizing overview. This is then transmitted to the operator station client 17 (step VI) and visually displayed by it along with the second installation image 9.

The alarm-itemized thumbnails (second installation image 9 and third installation image 14) enable the operator to better prioritize their operator control and monitoring tasks. Unnecessary screen changes and interruptions to the processing of existing tasks can be effectively avoided using the control system 15 described above.

The invention can therefore make a significant contribution to improving the operability of the control system of a technical installation.

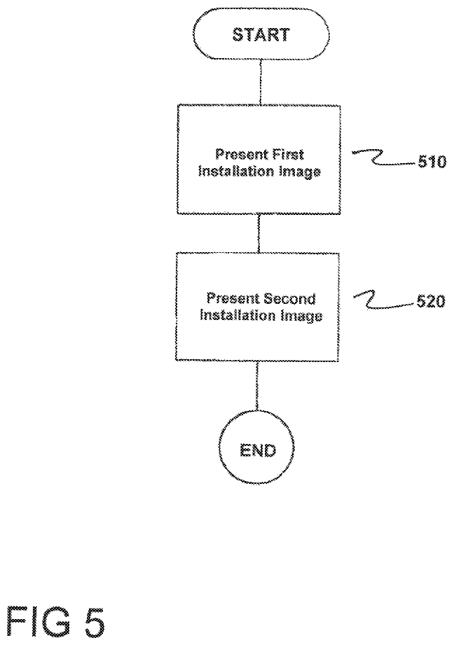

FIG. 5 is a flowchart of the method for operating a control system 15 for a technical installation, which comprises an operator station server 16 and an operator station client 17, where the operator station server 16 is configured to generate visualization information and to transmit the visualization information to the operator station client 17 for visualization, so as to enable operator control and monitoring of the technical installation, where the visualization information comprises at least one first installation image 1 and second installation image 9 of the technical installation, in which digital representations 2, 3, 4, 5, 6 of components of the technical installation and associated measurement data 7, 8, 9 for operator control and monitoring of the technical installation are visually or can be represented, and where the digital representations 2, 3, 4, 5, 6 of the first installation image 1 is different from the digital representations 2, 3, 4, 5, 6 of the second installation image 9.

The method comprises a) visually presenting the first installation image 1 to the operator by the operator station client 17, as indicated in step 510. Next, b) the second installation image 9 is visually presented to the operator by the operator station client 17 in response to an event occurring, as indicated in step 520.

In accordance with the method of the invention, the display size of the first installation image 1 and the second installation image 9 differ from one another, the display size of the second installation image 9 is smaller than the display size of the first installation image 1, and the display size is a number of pixels used by the operator station client 17 to visually display the installation images 1, 9 on a screen.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A control system for a technical installation, the control system comprising:
an operator station server; and
an operator station client;
wherein the operator station server is configured to generate visualization information and transmit said visualization information to the operator station client for visualization to enable an operator to control and monitor the technical installation;
wherein the visualization information comprises at least one first installation image and second installation image in which digital representations of components of the technical installation and associated measurement data for operator control and monitoring of the technical installation are one of visually displayable and visually displayed;
wherein the digital representations of the first installation image are different than the digital representations of the second installation image;
wherein the control system is configured to visually display the second installation image to the operator via the operator station client as the result of an event occurring during the visual presentation of the first installation image to the operator by the operator station client;
wherein a display size of the first installation image and the second installation image are designed as different from one another;
wherein a display size of the second installation image is smaller than the display size of the first installation image; and
wherein the display size is a number of pixels used by the operator station client to visually display the installation images on a screen.

17. The control system as claimed in claim 16, wherein an event represents an instruction issued by the operator.

18. The control system as claimed in claim 17, wherein the event represents selection of the second installation image from a list display of the installation images.

19. The control system as claimed in claim 18, wherein the second installation image is provided in the list display with a message occurring in the technical installation, in particular an alarm message.

20. The control system as claimed in claim 19, wherein the message occurring in the technical installation comprises an alarm message.

21. The control system as claimed in claim 16, wherein an event represents a message occurring in the technical installation, in particular an alarm message.

22. The control system as claimed in claim 21, wherein the message occurring in the technical installation comprises an alarm message.

23. The control system as claimed in claim 21, wherein the properties which the message must possess in order to trigger the visual display of the second installation image by the operator station client are predefinable.

24. The control system as claimed in claim 16, wherein the second installation image is displayable in an image window which is configured to be movable by the operator on an image display visually displayed by the operator station client.

25. The control system as claimed claim 16, wherein the visual display of the second installation image comprises an overview of alarm messages which are assigned to components of the technical installation which are comprised by the second installation image.

26. The control system as claimed in claim 25, wherein the overview comprises a respective number of alarm messages of a particular alarm class.

27. The control system as claimed in claim 16, wherein the visualization information additionally comprises at least one third installation image of the technical installation;
wherein the control system is configured designed to visually present the second installation image and the third installation image to the operator via the operator station client as the result of an event occurring or as the result of a plurality of events occurring during the visual presentation of the first installation image to the operator by the operator station client;
wherein a display size of the first installation image, the second installation image, the first installation image and the third installation image are formed differently from one another;
wherein a display size of the second installation image and the third installation image are smaller than the display size of the first installation image.

28. The control system as claimed in claim 16, wherein the technical installation comprises a process installation or production facility.

29. A method for operating a control system for a technical installation, which comprises an operator station server and an operator station client, the operator station server being configured to generate visualization information and to transmit said visualization information to the operator station client for visualization, so as to enable operator control and monitoring of the technical installation, the visualization information comprising at least one first installation image and second installation image of the technical installation, in which digital representations of components of the technical installation and associated measurement data for operator control and monitoring of the technical installation are one of visually represented and visually representable, and the digital representations of the first installation image being different from the digital representations of the second installation image, the method comprising:
(a) visually presenting the first installation image to the operator by the operator station client; and
b) visually presenting the second installation image to the operator by the operator station client in response to an event occurring;
wherein a display size of the first installation image and the second installation image differ from one another;
wherein the display size of the second installation image is smaller than the display size of the first installation image; and
wherein the display size is a number of pixels used by the operator station client to visually display the installation images on a screen.

30. The method as claimed in claim 29, wherein the event represents an instruction received from the operator.

31. The method as claimed in claim 29, wherein the event represents a message, in particular an alarm message, occurring in the technical installation.

32. The method as claimed in claim 29, wherein the a message occurring in the technical installation comprises an alarm message.

33. The method as claimed in claim 29, wherein the second installation image is displayed in an image window which is configured to be movable by the operator on an image display visually displayed by the operator station client.

34. The method as claimed in claim 29, wherein the visual display of the second installation image comprises an overview of alarm messages associated with components of the technical installation which are comprised by the second installation image.

35. The method as claimed in claim 29, wherein the technical installation comprises a process installation or production facility.
